(19) United States
(12) Patent Application Publication
(10) Pub. No.: US 2026/0204035 A1
(43) Pub. Date: Jul. 16, 2026

(54) METHOD, APPARATUS, DEVICE, COMPUTER READABLE STORAGE MEDIUM AND PRODUCT FOR EFFECT PROCESSING

(71) Applicant: Beijing Zitiao Network Technology Co., Ltd., Beijing (CN)

(72) Inventors: Pengjing SONG, Beijing (CN); Yehua LYU, Beijing (CN); Lin LI, Beijing (CN)

(21) Appl. No.: 19/136,210

(22) PCT Filed: Nov. 9, 2023
(86) PCT No.: PCT/CN2023/130694

§ 371 Date: Jun. 5, 2025

(30) Foreign Application Priority Data
Dec. 6, 2022 (CN) 202211559301.9

(51) Int. Cl. G06T 19/20; G06T 19/00

(52) U.S. Cl. CPC G06T 19/20; G06T 19/006; G06T 2219/2004; G06T 2219/2016

(57) ABSTRACT

Embodiments of the disclosure provide a method, apparatus, device, computer readable storage medium, and product for effect processing. The method includes: obtaining an effect calling request including a target effect; determining an initial posture and a following mechanism of a three-dimensional body in the target effect relative to a terminal device based on the effect calling request; obtaining movement information collected by the terminal device; controlling based on the initial posture, the following mechanism and the movement information, the three-dimensional body to perform a moving operation, to obtain a target three-dimensional motion trajectory; and displaying the target three-dimensional motion trajectory on the terminal device. In this way, the three-dimensional body can follow the effect of motion of the terminal device in real space, thus the effect of augmented reality is achieved.

This application claims priority to the Chinese Patent Application No. 202211559301.9, filed with the Chinese Patent Office on Dec. 6, 2022 and entitled “METHOD, APPARATUS, DEVICE, COMPUTER READABLE STORAGE MEDIUM AND PRODUCT FOR EFFECT PROCESSING”, which is incorporated herein by reference in its entirety.

### FIELD

Embodiments of the present disclosure relate to the field of image processing technologies, and in particular, to a method, apparatus, device, computer readable storage medium, and product for effect processing.

### BACKGROUND

With the improvement of terminal device hardware performance and continuous improvement of artificial intelligence technologies, virtual reality is used increasingly in real life.

In a process of driving a virtual reality three-dimensional object, in the prior art, key point information is generally used to map a transformation matrix of the three-dimensional object and a transformation matrix of key point information returned by an algorithm, so as to achieve a driving effect. Alternatively, driving based on a script is used. A transformation function is written and a transformation matrix returned by the function is assigned to the 3D object in each frame, so as to achieve the driving effect. Alternatively, an animation area is used. A direct play of the 3D object is performed in the animation system using an animation configuration file that is already made, thus the driving effect is achieved.

However, the driving effect of the three-dimensional object using the described solutions is generally not good. Moreover, each solution is limited to application scenarios and cannot be applied in a plurality of different application scenarios.

### SUMMARY

Embodiments of the present disclosure provide a method, apparatus, device, computer readable storage medium, and product for effect processing, which are used for solving the existing technical problem of poor three-dimensional object driving effect.

According to a first aspect, an embodiment of the present disclosure provides a method for effect processing, including: obtaining an effect calling request including a target effect; determining an initial posture and a following mechanism of a three-dimensional body in the target effect relative to a terminal device based on the effect calling request; obtaining movement information collected by the terminal device; controlling, based on the initial posture, the following mechanism and the movement information, the three-dimensional body to perform a moving operation, to obtain a target three-dimensional motion trajectory; and displaying the target three-dimensional motion trajectory on the terminal device.

According to a second aspect, an embodiment of the present disclosure provides an apparatus for effect processing, including: an obtaining module configured to obtain an effect calling request including a target effect; a determining module configured to determine an initial posture and a following mechanism of a three-dimensional body in the target effect relative to a terminal device based on the effect calling request; a movement information obtaining module configured to obtain movement information collected by the terminal device; a controlling module configured to control the three-dimensional body based on the initial posture, the following mechanism, and the movement information to perform a moving operation, to obtain a target three-dimensional motion trajectory; and a displaying module configured to display the target three-dimensional motion trajectory on the terminal device.

According to a third aspect, an embodiment of the present disclosure provides an electronic device, including: a processor and a memory; the memory stores computer execution instructions; the processor executes the computer execution instructions stored in the memory, so that at least one processor executes the method for effect processing according to the foregoing first aspect and various possible designs of the first aspect.

According to a fourth aspect, an embodiment of the present disclosure provides a computer readable storage medium. The computer readable storage medium stores computer execution instruction therein. When executing the computer execution instructions, a processor implements the method for effect processing according to the first aspect and various possible designs of the first aspect.

According to a fifth aspect, an embodiment of the present disclosure provides a computer program product, including a computer program. When executed by a processor, the computer program implements the method for effect processing according to the first aspect and various possible designs of the first aspect.

According to the method, apparatus, device, computer readable storage medium and product for effect processing provided in the embodiments, after obtaining an effect calling request, an initial posture and a following mechanism of a three-dimensional body in a target effect relative to a terminal device are determined. Movement information collected by a terminal device is obtained, and a three-dimensional body is controlled to perform a moving operation based on the initial posture, the following mechanism and the movement information. Thus the translation and rotation information collected by the terminal device is assigned to the three-dimensional body, such that a motion effect of the three-dimensional body is consistent with that of the terminal device. In this way, the effect of the three-dimensional body following the motion of the terminal device in real space is achieved, thus the effect of augmented reality is achieved.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description describe some embodiments of the present disclosure. For those skilled in the art, other drawings may also be obtained according to these drawings without creative efforts.

FIG. 1A is a system architecture diagram upon which the present disclosure is based;

FIG. 1B is yet another system architecture diagram upon which the present disclosure is based;

FIG. 2 is a schematic flowchart of a method for effect processing according to an embodiment of the present disclosure;

FIG. 3 is a schematic flowchart of a method for effect processing according to another embodiment of the present disclosure;

FIG. 4 is a schematic diagram of a first initial posture according to an embodiment of the present disclosure;

FIG. 5 is a schematic diagram of a second initial posture according to an embodiment of the present disclosure;

FIG. 6 is a schematic diagram of a third initial posture according to an embodiment of the present disclosure;

FIG. 7 is a schematic flowchart of a method for effect processing according to another embodiment of the present disclosure;

FIG. 8 is a schematic flowchart of a method for effect processing according to another embodiment of the present disclosure;

FIG. 9 is a schematic structural diagram of an apparatus for effect processing according to an embodiment of the present disclosure;

FIG. 10 is a structural schematic diagram of an electronic device according to an embodiment of the present disclosure.

### DETAILED DESCRIPTION

In order to make objects, technical solutions and advantages of the embodiments of the present disclosure more clear, the technical solutions in the embodiments of the present disclosure will be described below in a clearly and completely way in connection with the drawings in the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

In order to solve the existing technical problem of a poor three-dimensional object driving effect, the present disclosure provides a method, apparatus, device, computer readable storage medium, and product for effect processing.

It should be noted that the method, apparatus, device, computer readable storage medium, and product for effect processing provided by the present disclosure may be applied to any scenario of three-dimensional object driving.

Common three-dimensional object driving methods generally include determining key point information about a three-dimensional object, and achieving a driving effect by means of matrix transformation according to the key point information. However, by driving the three-dimensional object using the above method, the three-dimensional object cannot move accurately according to the movement of the terminal device, resulting in a mismatch in the driving effect and the movement of the terminal device, thus the display effect is poor.

In the process of solving the described technical problem, the inventor finds through research that, in order to improve the driving effect for a three-dimensional object to match the movement trajectory of the three-dimensional object with movement of the terminal device, movement information may be collected by a gyroscope prebuilt in the terminal device, and a driving operation is performed on the three-dimensional object based on the movement information and an initial posture and a following mechanism corresponding to the target effect.

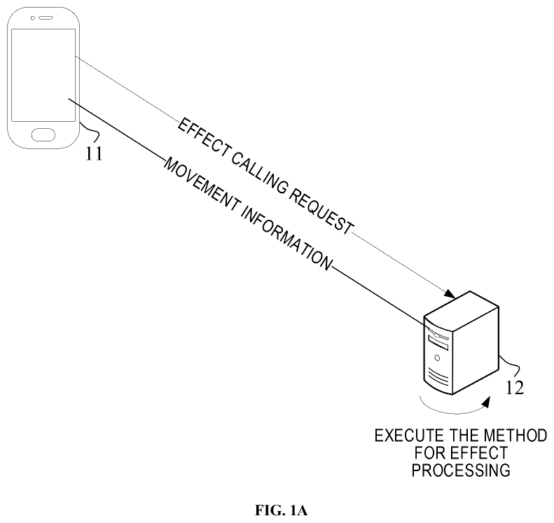

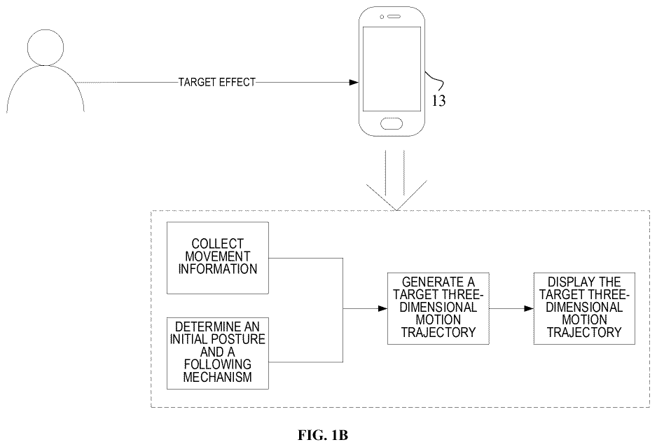

FIG. 1A is a system architecture diagram on which the present disclosure is based. As shown in FIG. 1A, the system on which the present disclosure is based at least includes a terminal device 11 and a server 12. An apparatus for effect processing can be provided in the server 12, and the apparatus for effect processing can be written in languages such as C/C++, Java, Shell or Python. The terminal device 11 may be, for example, a desktop computer or a tablet computer.

Based on the foregoing system architecture, the user may select a target effect to be displayed on the terminal device 11. The terminal device 11 sends an effect calling request to the server 12 based on the target effect. The server 12 may determine an initial posture and a following mechanism of a three-dimensional body in the target effect relative to the terminal device based on the effect calling request. The three-dimensional object is then driven according to the movement information obtained by the terminal device 11, the initial posture, and the following mechanism.

Alternatively, FIG. 1B is another system architecture diagram on which the present disclosure is based. As shown in FIG. 1B, the system architecture diagram on which the present disclosure is based includes at least a terminal device 13. The terminal device 13 may be provided with an apparatus for effect processing. The apparatus for effect processing may be written in a language such as C/C++, Java, Shell, or Python. The terminal device 13 includes, but is not limited to, a desktop computer, a tablet computer, a mobile phone, and the like.

Based on the foregoing system architecture, the user may determine a target effect on the terminal device 13 according to an actual requirement. After obtaining the target effect selected by the user, the terminal device 13 may further determine an initial posture and a following mechanism corresponding to the target effect. The terminal device 13 may collect movement information by using one or more predetermined sensors, and then may control, based on the initial posture, the following mechanism, and the movement information, a three-dimensional body to perform a moving operation, to obtain a target three-dimensional motion trajectory, and display the target three-dimensional motion trajectory.

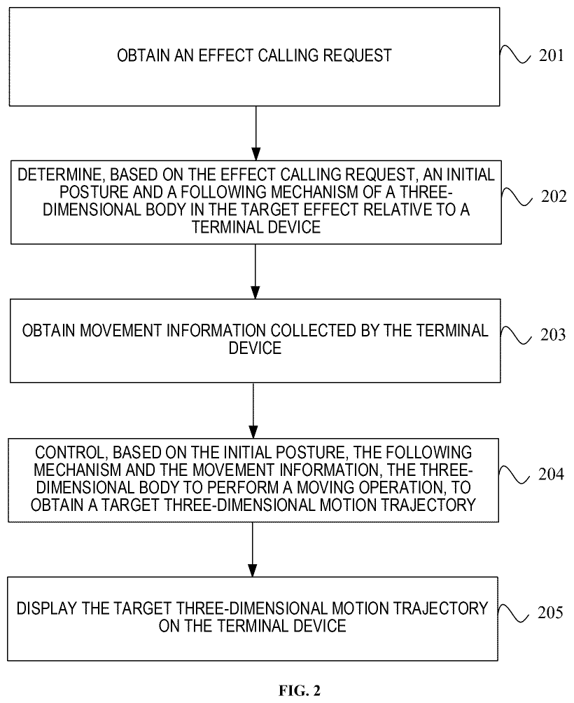

FIG. 2 is a schematic flowchart of a method for effect processing according to an embodiment of the present disclosure. As shown in FIG. 2, the method includes:

At step 201, an effect calling request is obtained, and the effect calling request includes a target effect.

The execution body of this embodiment is an apparatus for effect processing, and the apparatus for effect processing may be coupled to a server. The server can be communicatively connected with a terminal device, so that the movement information collected by the terminal device can be obtained to control a three-dimensional body. Optionally, the apparatus for effect processing may also be coupled to a terminal device, so as to control a three-dimensional body based on movement information collected by the terminal device.

In this embodiment, the target application may provide the user with a variety of effects, and each effect may include a three-dimensional body and a three-dimensional object. A user may select on a target application a target effect currently required to be displayed according to practical requirements, and if the target effect is an effect of driving cooking by a pot, a three-dimensional body may be the pot and the three-dimensional object may be a dish in the pot.

The server of the target application may initiate an effect calling request based on the target effect. Correspondingly, the apparatus for effect processing may obtain the effect calling request, and the effect calling request includes the target effect.

At step 202, an initial posture and a following mechanism of the three-dimensional body in the target effect relative to a terminal device is determined based on the effect calling request.

In this embodiment, in order to ensure a display effect for effect, for each effect, a corresponding initial posture and following mechanism may be set in advance for the effect. The initial posture is configured for controlling a rotating operation of the three-dimensional body and/or the three-dimensional object, and the following mechanism is configured for controlling a moving operation of the three-dimensional body and/or the three-dimensional object.

Therefore, after the effect calling request is obtained, the initial posture and the following mechanism of the three-dimensional body in the target effect relative to the terminal device may be determined according to the effect calling request.

At step 203, the movement information collected by the terminal device is obtained.

In this implementation, in order to achieve the effect of the three-dimensional body following the motion of the terminal device in real space, the three-dimensional body may be controlled according to the movement information collected by the terminal device. Therefore, the movement information collected by the terminal device may be obtained.

It should be noted that, a plurality of sensors for collecting movement information may be predetermined in the terminal device, and the movement information collected by any one or more sensors may be obtained.

At step 204, the three-dimensional body is controlled to perform a moving operation based on the initial posture, the following mechanism, and the movement information, to obtain a target three-dimensional motion trajectory.

In this implementation, after determining the initial posture and the following mechanism corresponding to the target effect and obtaining the movement information collected by the terminal device, the three-dimensional body can be controlled to perform a moving operation based on the initial posture, the following mechanism and the movement information, to obtain the target three-dimensional motion trajectory.

At step 205, the target three-dimensional motion trajectory is displayed on the terminal device.

In this implementation, after the target three-dimensional motion trajectory of the three-dimensional body is obtained, the target three-dimensional motion trajectory may be displayed on the terminal device. Thus, the motion effect of the three-dimensional body is consistent with that of the terminal device.

Optionally, specifically, movement information collected by a gyroscope prebuilt in the terminal device may be obtained.

The gyroscope is a device for detecting angular motion of a momentum-moment-sensitive shell of a high-speed rotating body with relative to inertial space around one or two axes orthogonal to a spinning axis. By assigning the movement information collected by the gyroscope to the three-dimensional body, the motion trajectory of the three-dimensional body can be highly matched with the terminal device, thereby improving the display effect of the target effect.

According to the method, apparatus, device, computer readable storage medium and product for effect processing provided in the embodiments, after obtaining an effect calling request, an initial posture and a following mechanism of a three-dimensional body in a target effect relative to a terminal device are determined. Movement information collected by a terminal device is obtained, and a three-dimensional body is controlled to perform a moving operation based on the initial posture, the following mechanism and the movement information. Thus the translation and rotation information collected by the terminal device is assigned to the three-dimensional body, such that a motion effect of the three-dimensional body is consistent with that of the terminal device. In this way, the effect of the three-dimensional body following the motion of the terminal device in real space is achieved, thus the effect of augmented reality is achieved.

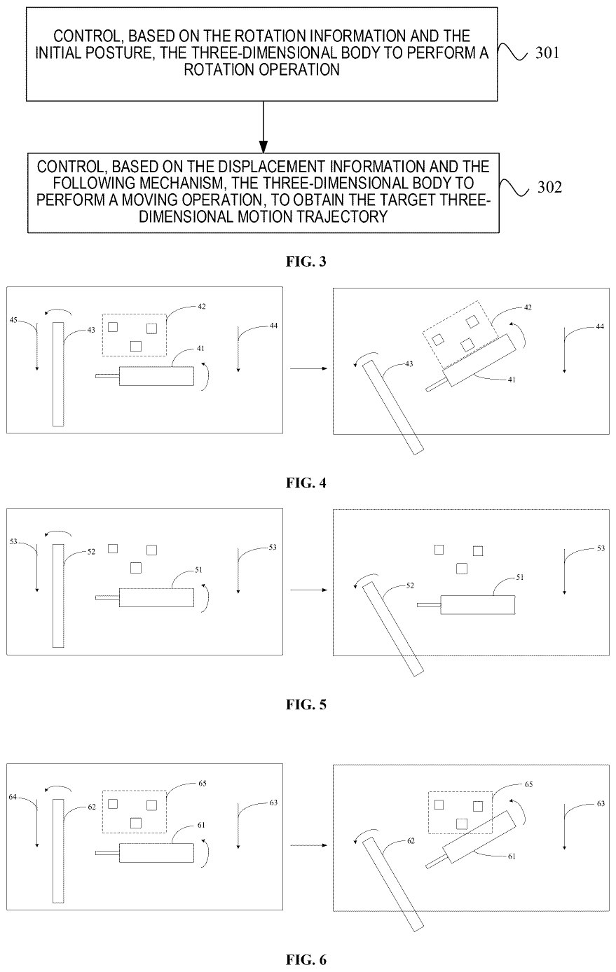

FIG. 3 is a schematic flowchart of a method for effect processing according to another embodiment of the present disclosure. Based on any one of the foregoing embodiments, the movement information includes rotation information and displacement information. As shown in FIG. 3, Step 204 includes:

At step 301, the three-dimensional body is controlled, based on the rotation information and the initial posture, to perform a rotating operation.

At step 302, the three-dimensional body is controlled, based on the displacement information and the following mechanism, to perform the moving operation to obtain the target three-dimensional motion trajectory.

In this embodiment, the movement information may specifically include rotation information and displacement information, where the rotation information may indicate a rotation angle of the terminal device, and the displacement information may indicate a movement distance of the terminal device.

After the movement information is obtained, the three-dimensional body may be controlled to rotate based on the rotation information and the initial posture. In this way, the rotation of the three-dimensional body may be consistent with that of the terminal device, and the moving operation of the three-dimensional body may be controlled based on the displacement information and the following mechanism, so that the movement of the three-dimensional body may be consistent with that of the terminal device. By controlling the moving operation and the rotating operation of the three-dimensional body based on the movement information, a three-dimensional motion trajectory that is consistent with the motion of the terminal device can be obtained.

In the method for effect processing provided in the present embodiment, the three-dimensional body is controlled to rotate based on the rotation information and the initial posture, and the three-dimensional body is controlled to move according to displacement information and a following mechanism, so that it can be ensured that the obtained target three-dimensional motion trajectory better conforms to the effect of the terminal device moving in a real space, thereby improving the realism of the movement of three-dimensional object.

Further, based on any one of the above embodiments, the initial posture may include any one of a first initial posture, a second initial posture and a third initial posture.

The first initial posture is configured such that there is a fixed angle between the terminal device and the three-dimensional body as well as a further three-dimensional object in the target effect, and a gravity direction of the three-dimensional body is consistent with a gravity direction of the terminal device.

The second initial posture is configured such that an angle between the three-dimensional body and the terminal device is not fixed, and a gravity direction of the three-dimensional body is consistent with a gravitational field of the earth.

The third initial posture is configured such that there is a fixed angle between the three-dimensional body and the terminal device, a gravity direction of the three-dimensional body is consistent with a gravity direction of the terminal device, and a further three-dimensional object in the target effect does not follow movement of the terminal device.

In this embodiment, the initial posture includes the first initial posture, the second initial posture, and the third initial posture.

The first initial posture is configured such that there is a fixed angle between the terminal device and the three-dimensional body as well as a further three-dimensional object in the target effect, and a gravity direction of the three-dimensional body is consistent with a gravity direction of the terminal device. In the case of the first initial posture, the coordinate system in which the further three-dimensional object is located is consistent with the virtual space coordinate system for the three-dimensional body. In order to ensure that the solution can achieve the sense of experiential realism, the three-dimensional body, the further three-dimensional object, and the terminal device can be considered as a whole, and an initial difference value between the virtual space coordinate system and a real space coordinate system should be a determined value, which is independent of an initial state of the terminal device.

The second initial posture is configured such that an angle between the three-dimensional body and the terminal device is not fixed, and a gravity direction of the three-dimensional body is consistent with a gravitational field of the earth. In the case of the second initial posture, the coordinate system of the three-dimensional object and the further three-dimensional object coincides with a coordinate system for the real space. In order to ensure that the solution can achieve the sense of experiential realism, the three-dimensional body and the further three-dimensional object should be considered as a whole, and a relative rotation deviation between the three-dimensional body and the plane of the terminal is calculated in real time based on the rotation information of the terminal, so as to adjust the posture of the three-dimensional body. Such a solution can ensure that the physical presentation of a virtual object always conforms to the user's cognitive effect in a real space, but it will unbundle the three-dimensional body and the terminal device, and the positional relationship between the two can be used in a scenario where there is no common knowledge restriction, for example, driving a pot for cooking.

The third initial posture is configured such that there is a fixed angle between the three-dimensional body and the terminal device, a gravity direction of the three-dimensional body is consistent with a gravity direction of the terminal device, and a further three-dimensional object in the target effect does not follow movement of the terminal device. In the case of the third initial posture, the coordinate system in which the further three-dimensional object locates coincides with the coordinate system for real space. In order to ensure that the solution can achieve the sense of experiential realism, the three-dimensional body and the terminal should be considered as a whole, and the three-dimensional body should keep consistent with the posture of the terminal at any moment. Such a solution can ensure that the physical presentation of further three-dimensional object interacting with the three-dimensional body always conforms to the user's cognitive effect in real space, which is suitable for driving of three-dimensional object of a hand-held object type, such as a pistol.

The method for effect processing provided in the present embodiment can realize accurate driving of a three-dimensional object in a plurality of different scenarios by respectively arranging a plurality of different initial postures, thereby improving the application scenarios of target effects.

Optionally, based on any one of the above embodiments, the initial posture includes a first initial posture, the first initial posture is configured such that there is a fixed angle between the terminal device and the three-dimensional body as well as a further three-dimensional object in the target effect, and a gravity direction of the three-dimensional body is consistent with a gravity direction of the terminal device. The step 301 includes the following.

In response to a determination that the initial posture is a predetermined first initial posture, controlling the three-dimensional body and the further three-dimensional object to rotate synchronously following the terminal device based on the rotation information.

In the present embodiment, when the initial posture is the first initial posture, the coordinate system in which the further three-dimensional object is located coincides with the virtual space coordinate system for three-dimensional body. In order to ensure that the solution can achieve the sense of experiential realism, the three-dimensional body, the further three-dimensional object, and the terminal device can be regarded as a whole, and the three-dimensional body and the further three-dimensional object can be controlled based on the rotation information to rotate synchronously following the terminal device.

FIG. 4 is a schematic diagram of a first initial posture according to an embodiment of the present disclosure. As shown in FIG. 4, there is a fixed angle between the three-dimensional body 41 as well as a further three-dimensional object 42 in the target effect and the terminal device 43, and a gravity direction 44 of the three-dimensional body 41 is consistent with a gravity direction 45 of the terminal device. As the terminal device 43 moves, the three-dimensional body 41 and further three-dimensional object 42 in the target effect rotate in synchronization with the terminal device 43.

Optionally, based on any one of the foregoing embodiments, the initial posture includes a second initial posture, and the second initial posture is configured such that an angle between the three-dimensional body and the terminal device is not fixed, and a gravity direction of the three-dimensional body is consistent with a gravitational field of the earth. The step 301 includes the following.

In response to a determination that the initial posture is a predetermined second initial posture, controlling, based on the rotation information, the three-dimensional body and the further three-dimensional object to maintain initial positions and refrain from rotating synchronously following the terminal device.

In the present embodiment, when the initial posture is the second initial posture, the coordinate system of the three-dimensional object and the further three-dimensional object coincides with the coordinate system of the real space. In order to ensure that the solution can achieve the sense of experiential realism, the three-dimensional body and the further three-dimensional object should be considered as a whole, and the three-dimensional body and the further three-dimensional object should be controlled based on the rotation information to maintain initial positions and refrain from rotating synchronously following the terminal device.

FIG. 5 is a schematic diagram of a second initial posture according to an embodiment of the present disclosure. As shown in FIG. 5, an angle between the three-dimensional body 51 and the terminal device 52 is not fixed, and a gravity direction 53 of the three-dimensional body 51 is consistent with a gravitational field of the earth. When the terminal device 52 moves, the three-dimensional body 51 does not synchronously rotate following the terminal device 52.

Optionally, on the basis of any of the above embodiments, the initial posture includes a third initial posture, there is a fixed angle between the three-dimensional body and the terminal device, a gravity direction of the three-dimensional body is consistent with a gravity direction of the terminal device, and the further three-dimensional object in the target effect does not follow movement of the terminal device. The step 301 includes the following.

In response to a determination that the initial posture is a predetermined third initial posture, the three-dimensional body is controlled, based on the rotation information, to rotate synchronously following the terminal device, and the further three-dimensional object is controlled to maintain an initial position and refrain from rotating synchronously following the terminal device.

In the present embodiment, when the initial posture is the third initial posture, the coordinate system in which the further three-dimensional object is located coincides with the coordinate system for the real space. In order to ensure that the solution can achieve the sense of experiential realism, the three-dimensional body and the terminal should be considered as a whole, and the three-dimensional body should keep consistent with the posture of the terminal at any moment. Therefore, the three-dimensional body can be controlled to rotate synchronously with the terminal device based on the rotation information, and the further three-dimensional object can be controlled to maintain the initial position without rotating synchronously with the terminal device.

FIG. 6 is a schematic diagram of a third initial posture according to an embodiment of the present disclosure. As shown in FIG. 6, there is a fixed angle between the three-dimensional body 61 and the terminal device 62, and a gravity direction 63 of the three-dimensional body 61 is consistent with a gravity direction 64 of the terminal device 62. When the terminal device 62 moves, the three-dimensional body 61 moves along with the terminal device 62, and a further three-dimensional object 65 in the target effect does not follow the movement of the terminal device 62.

According to the method for effect processing provided in this embodiment, the three-dimensional body is driven according to different initial postures and rotation information respectively, so that the driving operation for the three-dimensional body can be implemented in different application scenarios. In addition, in different application scenarios, the three-dimensional object in different effects can be driven accurately, thereby optimizing the display effect of the effects.

FIG. 7 is a schematic flowchart of a method for effect processing according to another embodiment of the present disclosure. Based on any one of the foregoing embodiments, as shown in FIG. 7, step 302 includes the following.

At step 701, a target position is determined based on the following mechanism and the displacement information.

At step 702, the three-dimensional body is controlled to move to the target position.

In this embodiment, after the following mechanism corresponding to the target effect and the displacement information collected by the terminal device are determined, in order to enable the movement of the three-dimensional body to be consistent with that of the terminal device, the target position may be determined based on the following mechanism and the displacement information, and the three-dimensional body is controlled to move to the target position.

According to the method for effect processing provided in this embodiment, the target position is determined according to the following mechanism and displacement information, and movement of the three-dimensional body is controlled according to the target position, so that a control operation can be accurately performed on the three-dimensional body.

Further, based on any one of the foregoing embodiments, the step 302 includes:
controlling the three-dimensional object to move based on the displacement information and controlling a further three-dimensional object to maintain an initial position.

Alternatively, the step 302 includes:
controlling the three-dimensional object and the further three-dimensional object to move based on the displacement information.

In the present embodiment, the following mechanism may include a first following mechanism and a second following mechanism. When the following mechanism is the first following mechanism, the three-dimensional object can be controlled to move based on the displacement information, and the further three-dimensional object can be controlled to maintain the initial position. For example, if the target effect is an effect of cooking food in a pot, a pot as the three-dimensional body can move based on the displacement information, and dishes in the pot, i.e., the three-dimensional object, can refrain from moving and following the terminal device, and thus a display effect like “shake pot” can be achieved.

When the following mechanism is the second following mechanism, the three-dimensional object and further three-dimensional object can be controlled to move based on the displacement information.

According to the method for effect processing provided in this embodiment, different following mechanisms are predetermined, so that the three-dimensional body can be accurately controlled in different application scenarios. In addition, in different application scenarios, three-dimensional objects in different effects can be driven accurately, thereby optimizing the display effect of the effects.

Further, based on any one of the foregoing embodiments, after step 302, the method further includes:
calculating, in real time, whether a movement range of the three-dimensional body is greater than a predetermined posture change threshold; and
in response to the movement range of the three-dimensional body being greater than the predetermined posture change threshold, controlling the three-dimensional body to perform the moving operation based on the posture change threshold.

In this embodiment, when the terminal device moves dramatically, in order to avoid a large displacement of the three-dimensional body from exceeding the range of screen display, a posture change threshold may be predetermined. A real-time calculation is performed to determine whether a movement range of the three-dimensional body is greater than a predetermined posture change threshold, and in accordance with a determination that the movement range of the three-dimensional body is greater than the predetermined posture change threshold, the three-dimensional body is controlled to perform the moving operation based on the posture change threshold. Otherwise, the three-dimensional body is controlled to move according to the movement range.

According to the method for effect processing provided in this embodiment, a posture change threshold is predetermined, and movement of a three-dimensional body is controlled based on the posture change threshold, so that the problem of poor display effect caused by an excessively large movement range of the three-dimensional body can be avoided, and the display effect of the effects is further optimized.

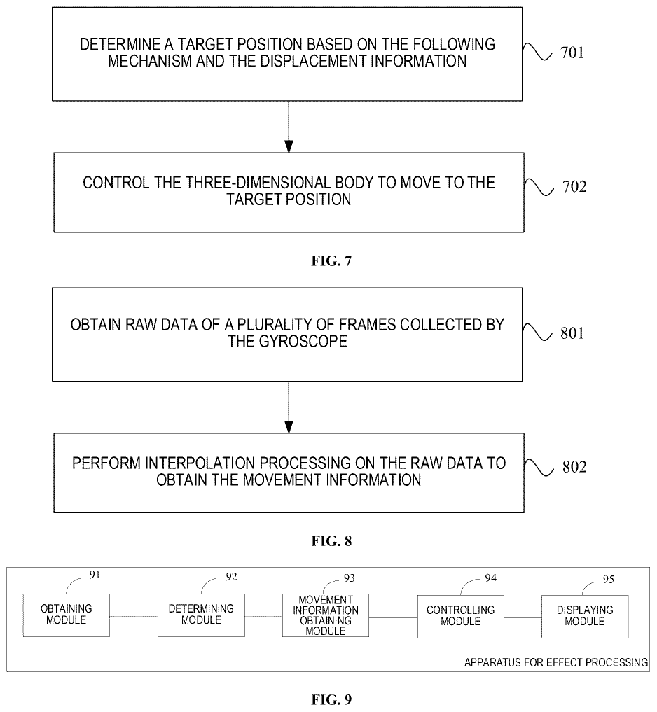

FIG. 8 is a schematic flowchart of a method for effect processing according to another embodiment of the present disclosure. Based on any one of the foregoing embodiments, the step 203 includes the following.

At step 801, raw data of a plurality of frames collected by the terminal device is obtained.

At step 802, interpolation processing is performed on the raw data to obtain the movement information.

In this embodiment, since the accuracy of raw data of a plurality of frames collected by the terminal device is generally not high, controlling the three-dimensional object based on the raw data may result in a poor display effect. Therefore, the raw data of a plurality of frames collected by the terminal device may be obtained, and the interpolation processing may be performed on the raw data of the plurality of frames collected by the terminal device, so as to obtain movement information.

Further, based on any of the foregoing embodiments, the step 802 includes:
obtaining raw data of a current frame of and raw data of a predetermined number of frames before the raw data of the current frame; and
calculating an average value between the raw data of the current frame and the raw data of the predetermined number of frames to obtain the movement information.

In this embodiment, the raw data of the current frame and the raw data of a predetermined number of frames before the raw data of the current frame may be obtained. The average value between raw data of the current frame and the raw data of the predetermined number of frames is calculated, so as to realize interpolation processing on the raw data of the plurality of frames, to obtain movement information.

According to the method for effect processing provided in this embodiment, after raw data of a plurality of frames collected by the terminal device are obtained, interpolation processing is performed on the raw data to obtain movement information, so that the accuracy of driving three-dimensional body can be improved.

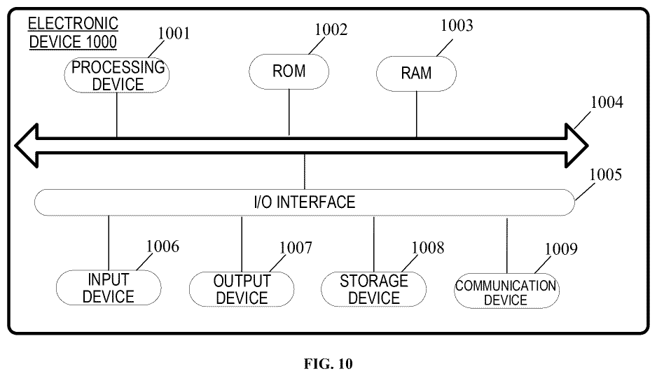

FIG. 9 is a schematic structural diagram of an apparatus for effect processing according to an embodiment of the present disclosure. As shown in FIG. 9, the apparatus for effect processing includes: an obtaining module 91, a determining module 92, a movement information obtaining module 93, a controlling module 94, and a displaying module 95. The obtaining module 91 is configured to obtain an effect calling request including a target effect. The determining module 92 is configured to determine, based on the effect calling request, an initial posture and a following mechanism of a three-dimensional body in the target effect relative to a terminal device. The movement information obtaining module 93 is configured to obtain movement information collected by the terminal device. The control module 94 is configured to control the three-dimensional body based on the initial posture, the following mechanism, and the movement information to perform a moving operation, to obtain a target three-dimensional motion trajectory. The displaying module 95 is configured to display the target three-dimensional motion trajectory on the terminal device.

Further, on the basis of any one of the above embodiments, the movement information includes rotation information and displacement information, and the control module is configured to control, based on the rotation information and the initial posture, the three-dimensional body to perform a rotating operation; and control, based on the displacement information and the following mechanism, the three-dimensional body to perform a moving operation, to obtain a target three-dimensional motion trajectory.

Further, based on any one of the above embodiments, the initial posture may include any one of a first initial posture, a second initial posture and a third initial posture. The first initial posture is configured such that there is a fixed angle between the terminal device and the three-dimensional body as well as a further three-dimensional object in the target effect, and a gravity direction of the three-dimensional body is consistent with a gravity direction of the terminal device. The second initial posture is configured such that an angle between the three-dimensional body and the terminal device is not fixed, and a gravity direction of the three-dimensional body is consistent with a gravitational field of the earth. The third initial posture is configured such that there is a fixed angle between the three-dimensional body and the terminal device, a gravity direction of the three-dimensional body is consistent with a gravity direction of the terminal device, and the further three-dimensional object in the target effect does not follow movement of the terminal device.

Further, on the basis of any of the above embodiments, the control module is configured to control the three-dimensional body and a further three-dimensional object based on the rotation information to rotate synchronously following the terminal device, in response to a determination that the initial posture is a predetermined first initial posture.

Further, on the basis of any of the described embodiments, the control module is configured to control the three-dimensional body and a further three-dimensional object based on the rotation information to maintain initial positions and refrain from rotating synchronously following the terminal device, in response to a determination that the initial posture is a predetermined second initial posture.

Further, on the basis of any of the described embodiments, the control module is configured to control, based on the rotation information, the three-dimensional body to rotate synchronously following the terminal device, and a further three-dimensional object to maintain an initial position and refrain from rotating synchronously following the terminal device, in response to a determination that the initial posture is a predetermined third initial posture.

Further, based on any one of the above embodiments, the control module is configured to determine a target position based on the following mechanism and the displacement information; and control the three-dimensional body to move to the target position.

Further, on the basis of any of the above embodiments, the control module is configured to control the three-dimensional object to move and a further three-dimensional object to maintain an initial position, based on the displacement information. Or, the control module is configured to control the three-dimensional object and the further three-dimensional object to move based on the displacement information.

Further, based on any one of the foregoing embodiments, the apparatus further includes: a calculation module configured to calculate, in real time, whether a movement range of the three-dimensional body is greater than a predetermined posture change threshold; and a processing module configured to control the three-dimensional body based on the posture change threshold to move, in response to the movement range of the three-dimensional body being greater than the predetermined posture change threshold.

Further, on the basis of any one of the above embodiments, the movement information obtaining module is configured to obtain raw data of a plurality of frames collected by the terminal device; and perform an interpolation process on the raw data to obtain the movement information.

Further, on the basis of any one of the foregoing embodiments, the movement information obtaining module is configured to obtain raw data of a current frame and raw data of a predetermined number of frames before the raw data of the current frame; and calculate an average value between the raw data of the current frame and the raw data of the predetermined number of frames to obtain the movement information.

The apparatus provided in this embodiment may be used to execute the technical solutions of the foregoing method embodiments, and implementation principles and technical effects of the apparatus are similar, and are not repeatedly described herein in this embodiment.

In order to achieve the described embodiments, the embodiments of the present disclosure further provide an electronic device, including a processor and a memory, the memory stores computer-executable instructions. The processor executes the computer execution instruction stored in the memory, so that the processor executes the method for effect processing according to any one of the foregoing embodiments.

FIG. 10 is a schematic structural diagram of an electronic device according to an embodiment of the present disclosure. As shown in FIG. 10, the electronic device 1000 may be a terminal device or a server. The terminal device may include, but is not limited to, a mobile terminal such as a mobile phone, a laptop computer, a digital broadcast receiver, a personal digital assistant (Personal Digital Assistant, PDA for short), a tablet computer (Portable Android Device, PAD for short), a portable multimedia player (Portable Media Player, PMP for short), a vehicle-mounted terminal (for example, a vehicle-mounted navigation terminal), and the like, and a fixed terminal such as a digital TV, a desktop computer, and the like. The electronic device shown in FIG. 10 is merely an example and should not bring any limitation to the functions and scope of use of the embodiments of the present disclosure.

As shown in FIG. 10, the electronic device 1000 may include a processing device (e. g., central processing unit, graphics processor, etc.) 1001 that may perform various suitable actions and processes in accordance with a program stored in a read only memory (ROM) 1002 or a program loaded into a random access memory (RAM) 1003 from a storage device 1008. In the RAM 1003, various programs and data necessary for the operation of the electronic apparatus 1000 are also stored. The processing devices 1001, the ROM 1002, and the RAM 1003 are connected to each other via a bus 1004. An input/output (I/O) interface 1005 is also connected to the bus 1004.

In general, the following devices may be connected to the I/O interface 1005: an input device 1006 including, for example, a touch screen, touch pad, keyboard, mouse, camera, microphone, accelerometer, gyroscope, or the like; an output device 1007 including, for example, a liquid crystal display (LCD), a speaker, a vibrator, or the like; a storage device 1008 including, for example, a magnetic tape, a hard disk, or the like; and a communication device 1009. The communication device 1009 may allow the electronic device 1000 to communicate wirelessly or with other devices to exchange data. While FIG. 10 illustrates the electronic device 1000 with a variety of devices, it should be understood that it is not required that all of the illustrated devices be implemented or provided. More or fewer devices may alternatively be implemented or provided.

In particular, the processes described above with reference to the flowcharts can be implemented as computer software programs, in accordance with embodiments of the present disclosure. For example, embodiments of the present disclosure include a computer program product including a computer program carried on a computer readable medium. The computer program includes a program code for executing the method as shown in the flowchart. In such an embodiment, the computer program may be downloaded and installed from the network via communications device 1009, installed from storage 1008, or installed from ROM 1002. When the computer program is executed by the processing device 1001, the above-described functions defined in the method according to the embodiment of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium (other than the computer readable storage medium) that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (radio frequency), etc., or any suitable combination of the foregoing.

Embodiments of the present disclosure further provide a computer readable storage medium. The computer readable storage medium stores a computer execution instruction. When a processor executes the computer execution instruction, the method for effect processing according to any one of the above embodiments is implemented.

An embodiment of the present disclosure further provides a computer program product including a computer program, wherein the computer program implements the method for effect processing according to any one of the above embodiments when being executed by a processor.

The computer readable medium may be included in the electronic device, or may exist separately and not be installed in the electronic device.

The computer readable medium carries one or more programs thereon, and when the one or more programs are executed by the electronic device, the electronic device is enabled to execute the method shown in the foregoing embodiments.

Computer program codes for performing the operations of the present disclosure may be written in one or more programming languages or a combination thereof, including but not limited to Object Oriented programming languages—such as Java, Smalltalk, C++, and also conventional procedural programming languages—such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case, for example, a first obtaining unit may also be described as “a unit for obtaining at least two internet protocol addresses”.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to a first aspect, according to one or more embodiments of the present disclosure, a method for effect processing, including: obtaining an effect calling request including a target effect; determining an initial posture and a following mechanism of a three-dimensional body in the target effect relative to a terminal device based on the effect calling request; obtaining movement information collected by the terminal device; controlling, based on the initial posture, the following mechanism and the movement information, the three-dimensional body to perform a moving operation, to obtain a target three-dimensional motion trajectory; and displaying the target three-dimensional motion trajectory on the terminal device.

According to one or more embodiments of the present disclosure, the movement information includes rotation information and displacement information, and controlling the three-dimensional body based on the initial posture, the following mechanism, and the movement information to perform the moving operation, to obtain the target three-dimensional motion trajectory includes: controlling the three-dimensional body based on the rotation information and the initial posture to perform a rotating operation; and controlling the three-dimensional body based on the displacement information and the following mechanism to perform a moving operation, to obtain the target three-dimensional motion trajectory.

According to one or more embodiments of the present disclosure, the initial posture includes any one of a first initial posture, a second initial posture and a third initial posture; the first initial posture is configured such that there is a fixed angle between the terminal device and the three-dimensional body as well as a further three-dimensional object in the target effect, and a gravity direction of the three-dimensional body is consistent with a gravity direction of the terminal device; the second initial posture is configured such that an angle between the three-dimensional body and the terminal device is not fixed, and a gravity direction of the three-dimensional body is consistent with a gravitational field of the earth; the third initial posture is configured such that there is a fixed angle between the three-dimensional body and the terminal device, a gravity direction of the three-dimensional body is consistent with a gravity direction of the terminal device, and the further three-dimensional object in the target effect does not follow movement of the terminal device.

According to one or more embodiments of the present disclosure, controlling the three-dimensional body based on the rotation information and the initial posture to perform the rotating operation includes: in response to the initial posture being a first initial posture, controlling the three-dimensional body and a further three-dimensional object based on the rotation information to rotate synchronously following the terminal device.

According to one or more embodiments of the present disclosure, controlling the three-dimensional body based on the rotation information and the initial posture to perform the rotating operation includes: in response to the initial posture being a second initial posture, controlling the three-dimensional body and a further three-dimensional object based on the rotation information to maintain initial positions and refrain from rotating synchronously following the terminal device.

According to one or more embodiments of the present disclosure, controlling the three-dimensional body based on the rotation information and the initial posture to perform the rotating operation includes: in response to the initial posture being a third initial posture, controlling, based on the rotation information, the three-dimensional body to rotate synchronously following the terminal device, and a further three-dimensional object to maintain an initial position and refrain from rotating synchronously following the terminal device.

According to one or more embodiments of the present disclosure, controlling the three-dimensional body based on the displacement information and the following mechanism to perform the moving operation includes: determining a target position based on the following mechanism and the displacement information; and controlling the three-dimensional body to move to the target position.

According to one or more embodiments of the present disclosure, controlling the three-dimensional body based on the displacement information and the following mechanism to perform the moving operation includes:
controlling the three-dimensional object to move and controlling a further three-dimensional object to maintain an initial position, based on the displacement information; or, controlling the three-dimensional body based on the displacement information and the following mechanism to perform the moving operation includes: controlling the three-dimensional object and the further three-dimensional object to move based on the displacement information.

According to one or more embodiments of the present disclosure, the method further includes after controlling the three-dimensional body based on the initial posture, the following mechanism, and the movement information to perform the moving operation, calculating, in real time, whether a movement range of the three-dimensional body is greater than a predetermined posture change threshold; and in response to the movement range of the three-dimensional body being greater than the predetermined posture change threshold, controlling the three-dimensional body based on the posture change threshold to perform the moving operation.

According to one or more embodiments of the present disclosure, obtaining the movement information collected by the terminal device includes: obtaining raw data of a plurality of frames collected by the terminal device; and performing interpolation processing on the raw data to obtain the movement information.

According to one or more embodiments of the present disclosure, performing the interpolation processing on the raw data to obtain the movement information includes: obtaining raw data of a current frame and raw data of a predetermined number of frames before the raw data of the current frame; and calculating an average value between the raw data of the current frame and the raw data of the predetermined number of frames to obtain the movement information.

According to one or more embodiments of the present disclosure, an apparatus for effect processing is provided, including: an obtaining module configured to obtain an effect calling request including a target effect; a determining module configured to determine an initial posture and a following mechanism of a three-dimensional body in the target effect relative to a terminal device based on the effect calling request; a movement information obtaining module configured to obtain movement information collected by the terminal device; a controlling module configured to control the three-dimensional body based on the initial posture, the following mechanism, and the movement information to perform a moving operation, to obtain a target three-dimensional motion trajectory; and a displaying module configured to display the target three-dimensional motion trajectory on the terminal device.

According to one or more embodiments of the present disclosure, the movement information includes rotation information and displacement information, and the control module is configured to: control the three-dimensional body based on the rotation information and the initial posture to perform a rotating operation; and control the three-dimensional body based on the displacement information and the following mechanism to perform a moving operation, to obtain the target three-dimensional motion trajectory.

According to one or more embodiments of the present disclosure, the initial posture includes any one of a first initial posture, a second initial posture and a third initial posture; the first initial posture is configured such that there is a fixed angle between the terminal device and the three-dimensional body as well as a further three-dimensional object in the target effect, and a gravity direction of the three-dimensional body is consistent with a gravity direction of the terminal device; the second initial posture is configured such that an angle between the three-dimensional body and the terminal device is not fixed, and a gravity direction of the three-dimensional body is consistent with a gravitational field of the earth; the third initial posture is configured such that there is a fixed angle between the three-dimensional body and the terminal device, a gravity direction of the three-dimensional body is consistent with a gravity direction of the terminal device, and the further three-dimensional object in the target effect does not follow movement of the terminal device.

According to one or more embodiments of the present disclosure, the control module is configured to: in response to a determination that the initial posture is a predetermined first initial posture, control the three-dimensional body and a further three-dimensional object based on the rotation information to rotate synchronously following the terminal device.

According to one or more embodiments of the present disclosure, the control module is configured to: in response to a determination that the initial posture is a predetermined second initial posture, control the three-dimensional body and a further three-dimensional object based on the rotation information to maintain initial positions and refrain from rotating synchronously following the terminal device.

According to one or more embodiments of the present disclosure, the control module is configured to: in response to a determination that the initial posture is a predetermined third initial posture, controlling, based on the rotation information, the three-dimensional body to rotate synchronously following the terminal device, and a further three-dimensional object to maintain an initial position and refrain from rotating synchronously following the terminal device.

According to one or more embodiments of the present disclosure, the control module is configured to: determine a target position based on the following mechanism and the displacement information; and control the three-dimensional body to move to the target position.

According to one or more embodiments of the present disclosure, the control module is configured to: control the three-dimensional object to move and control the further three-dimensional object to maintain the initial positions based on the displacement information; or the control module is configured to: control the three-dimensional object and the further three-dimensional object to move based on the displacement information.

According to one or more embodiments of the present disclosure, the apparatus further includes: a calculation module configured to calculate in real time whether a movement range of the three-dimensional body is greater than a predetermined posture change threshold; and a processing module configured to control, in response to the movement range of the three-dimensional body being greater than the predetermined posture change threshold, the three-dimensional body based on the posture change threshold to perform the moving operation.

According to one or more embodiments of the present disclosure, the movement information obtaining module is configured to: obtain raw data of a plurality of frames collected by the terminal device; perform an interpolation process on the raw data to obtain the movement information.

According to one or more embodiments of the present disclosure, the movement information obtaining module is configured to: obtain raw data of a current frame and raw data of a predetermined number of frames before the raw data of the current frame; calculate an average value between the raw data of the current frame and the raw data of the predetermined number of frames to obtain the movement information.

According to a third aspect, according to one or more embodiments of the present disclosure, there is provided an electronic device, including: at least one processor and a memory; the memory stores computer execution instructions; the at least one processor executes the computer execution instructions stored in the memory, so that the at least one processor executes the method for effect processing according to the first aspect and various possible designs of the first aspect.

In a fourth aspect, according to one or more embodiments of the present disclosure, a computer readable storage medium is provided. The computer readable storage medium stores computer execution instructions. When executing the computer execution instructions, a processor implements the method for effect processing according to the first aspect and various possible designs of the first aspect.

According to a fifth aspect, according to one or more embodiments of the present disclosure, a computer program product is provided, including a computer program, where the computer program, when executed by a processor, implements the foregoing method for effect processing according to the first aspect and various possible designs of the first aspect.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although a plurality of operations are depicted in a specific order, this should not be understood as requiring these operations to be performed in the specific order shown or in a sequential order. In certain environments, multitasking and parallel processing may be advantageous. Similarly, although a plurality of implementation details are included in the above discussion, these should not be construed as limiting the scope of the present disclosure. Some features described in the context of individual embodiments can also be implemented in combination in a single embodiment. Conversely, a plurality of features described in the context of a single embodiment can also be implemented in a plurality of embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1. A method for effect processing, comprising:
obtaining an effect calling request comprising an effect;
determining, based on the effect calling request, an initial posture and a following mechanism of a three-dimensional body in the target effect relative to a terminal device;
obtaining movement information collected by the terminal device;
controlling, based on the initial posture, the following mechanism and the movement information, the three-dimensional body to perform a moving operation, to obtain a three-dimensional motion trajectory; and
displaying the three-dimensional motion trajectory on the terminal device.

2. The method according to claim 1, wherein the movement information comprises rotation information and displacement information, and controlling, based on the initial posture, the following mechanism and the movement information, the three-dimensional body to perform the moving operation, to obtain the three-dimensional motion trajectory comprises:
controlling, based on the rotation information and the initial posture, the three-dimensional body to perform a rotating operation; and
controlling, based on the displacement information and the following mechanism, the three-dimensional body to perform a moving operation, to obtain the three-dimensional motion trajectory.

3. The method according to claim 2, wherein controlling, based on the rotation information and the initial posture, the three-dimensional body to perform the rotating operation comprises:
in response to a determination that the initial posture is a predetermined first initial posture, controlling, based on the rotation information, the three-dimensional body and a further three-dimensional object to rotate synchronously following the terminal device.

4. The method according to claim 2, wherein controlling, based on the rotation information and the initial posture, the three-dimensional body to perform the rotating operation comprises:
in response to a determination that the initial posture is a predetermined second initial posture, controlling, based on the rotation information, the three-dimensional body and a further three-dimensional object to maintain initial positions and refrain from rotating synchronously following the terminal device.

5. The method according to claim 2, wherein controlling, based on the rotation information and the initial posture, the three-dimensional body to perform the rotating operation comprises:
in response to a determination that the initial posture is a predetermined third initial posture, controlling, based on the rotation information, the three-dimensional body to rotate synchronously following the terminal device, and a further three-dimensional object to maintain an initial position and refrain from rotating synchronously following the terminal device.

6. The method according to claim 2, wherein controlling, based on the displacement information and the following mechanism, the three-dimensional body to perform the moving operation comprises:
determining a first position based on the following mechanism and the displacement information; and
controlling the three-dimensional body to move to the first position.

7. The method according to claim 2, wherein controlling, based on the displacement information and the following mechanism, the three-dimensional body to perform the moving operation comprises:
controlling the three-dimensional object to move based on the displacement information and controlling a further three-dimensional object to maintain an initial position; or
controlling, based on the displacement information and the following mechanism, the three-dimensional body to perform the moving operation comprises:
controlling the three-dimensional object and the further three-dimensional object to move based on the displacement information.

8. The method according to claim 1, wherein the initial posture comprises any one of a first initial posture, a second initial posture and a third initial posture;
wherein the first initial posture is configured such that there is a fixed angle between the terminal device and the three-dimensional body as well as a further three-dimensional object in the effect, a gravity direction of the three-dimensional body being consistent with a gravity direction of the terminal device;
the second initial posture is configured such that an angle between the three-dimensional body and the terminal device is not fixed, a gravity direction of the three-dimensional body being consistent with a gravitational field of the earth; and
the third initial posture is configured such that there is a fixed angle between the three-dimensional body and the terminal device, a gravity direction of the three-dimensional body being consistent with a gravity direction of the terminal device, and a further three-dimensional object in the effect not following movement of the terminal device.

9. The method according to claim 1, wherein the method further comprises after controlling based on the initial posture, the following mechanism and the movement information, the three-dimensional body to perform the moving operation,
calculating, in real time, whether a movement range of the three-dimensional body is greater than a predetermined posture change threshold; and
in accordance with a determination that the movement range of the three-dimensional body is greater than the predetermined posture change threshold, controlling the three-dimensional body to perform the moving operation based on the posture change threshold.

10. The method according to claim 1, wherein obtaining the movement information collected by the terminal device comprises:
obtaining raw data of a plurality of frames collected by the terminal device; and
performing interpolation processing on the raw data to obtain the movement information.

11. The method according to claim 9, wherein performing the interpolation processing on the raw data to obtain the movement information comprises:
obtaining raw data of a current frame and raw data of a predetermined number of frames before the raw data of the current frame; and
calculating an average value between the raw data of the current frame and the raw data of the predetermined number of frames to obtain the movement information.

12. The method according to claim 1, wherein obtaining the movement information collected by the terminal device comprises:
obtaining the movement information collected by a gyroscope prebuilt in the terminal device.

13. (canceled)

14. An electronic device, comprising: a processor and a memory;
the memory storing computer execution instructions;
the computer execution instructions stored in the memory, when executed by the processor, causing the processor to perform acts comprising:
obtaining an effect calling request comprising an effect;
determining, based on the effect calling request, an initial posture and a following mechanism of a three-dimensional body in the effect relative to a terminal device;
obtaining movement information collected by the terminal device;
controlling, based on the initial posture, the following mechanism and the movement information, the three-dimensional body to perform a moving operation, to obtain a three-dimensional motion trajectory; and
displaying the target three-dimensional motion trajectory on the terminal device.

15. A non-transitory computer readable storage medium, wherein the computer readable storage medium stores computer execution instructions thereon, and when executing the computer execution instructions, a processor implements a method comprising:
obtaining an effect calling request comprising an effect;
determining, based on the effect calling request, an initial posture and a following mechanism of a three-dimensional body in the effect relative to a terminal device;
obtaining movement information collected by the terminal device;
controlling, based on the initial posture, the following mechanism and the movement information, the three-dimensional body to perform a moving operation, to obtain a three-dimensional motion trajectory; and
displaying the three-dimensional motion trajectory on the terminal device.

16. (canceled)

17. The device according to claim 14, wherein the movement information comprises rotation information and displacement information, and controlling, based on the initial posture, the following mechanism and the movement information, the three-dimensional body to perform the moving operation, to obtain the three-dimensional motion trajectory comprises:
controlling, based on the rotation information and the initial posture, the three-dimensional body to perform a rotating operation; and
controlling, based on the displacement information and the following mechanism, the three-dimensional body to perform a moving operation, to obtain the three-dimensional motion trajectory.

18. The device according to claim 17, wherein controlling, based on the rotation information and the initial posture, the three-dimensional body to perform the rotating operation comprises:
in response to a determination that the initial posture is a predetermined first initial posture, controlling, based on the rotation information, the three-dimensional body and a further three-dimensional object to rotate synchronously following the terminal device.

19. The device according to claim 17, wherein controlling, based on the rotation information and the initial posture, the three-dimensional body to perform the rotating operation comprises:
in response to a determination that the initial posture is a predetermined second initial posture, controlling, based on the rotation information, the three-dimensional body and a further three-dimensional object to maintain initial positions and refrain from rotating synchronously following the terminal device.

20. The device according to claim 17, wherein controlling, based on the rotation information and the initial posture, the three-dimensional body to perform the rotating operation comprises:
in response to a determination that the initial posture is a predetermined third initial posture, controlling, based on the rotation information, the three-dimensional body to rotate synchronously following the terminal device, and a further three-dimensional object to maintain an initial position and refrain from rotating synchronously following the terminal device.

21. The device according to claim 17, wherein controlling, based on the displacement information and the following mechanism, the three-dimensional body to perform the moving operation comprises:
determining a first position based on the following mechanism and the displacement information; and
controlling the three-dimensional body to move to the first position.

22. The device according to claim 17, wherein controlling, based on the displacement information and the following mechanism, the three-dimensional body to perform the moving operation comprises:
controlling the three-dimensional object to move based on the displacement information and controlling a further three-dimensional object to maintain an initial position; or
controlling, based on the displacement information and the following mechanism, the three-dimensional body to perform the moving operation comprises:
controlling the three-dimensional object and the further three-dimensional object to move based on the displacement information.
